(19) United States
(12) Patent Application Publication
(10) Pub. No.: US 2008/0084574 A1
(43) Pub. Date: Apr. 10, 2008

(54) AUTOMATED PRINTING

(75) Inventors: Brent A. McDonald, Burnaby (CA); Alastair D. Foreman, North Vancouver (CA); Bruce A. Cowan, Port Moody (CA)

Correspondence Address: David A. Novais;Patent Legal Staff, Eastman Kodak Company, 343 State Street, Rochester, NY, 14650-2201, US

(73) Assignee: Eastman Kodak Company

(21) Appl. No.: 11/538,937

(22) Filed: Oct. 5, 2006

(51) Int. Cl. G06F 3/12

(52) U.S. Cl. 358/1.15

(57) ABSTRACT

A computerized method and apparatus for automated printing based on a submitted print order from an internet storefront is presented. A user configures a pictorial workflow plan which can dynamically respond to a printing intent derived from the submitted print order. The workflow plan automatically generates a value for a printing process element based on the dynamic printing intent. The visual nature of the pictorial plan and the integration between the storefront and printing system provides a simplified environment for configuring and maintaining workflow plans corresponding to a wide range of orderable products and printing equipment.

### FIELD OF THE INVENTION

This invention relates to automated workflow plans for controlling print operations. In particular, the invention pertains to the creation of easy-to-use pictorial workflow plans for automatically establishing control parameters for print processing steps based on printing intent specified by a customer in an electronically received print order.

### BACKGROUND OF THE INVENTION

Commercial printing of a print order can be a complex process involving many operations, each requiring specific control parameters to achieve the desired outcome. There can be many types of printing equipment for performing these operations, including prepress (e.g. printable content file processing), press (e.g. printing) and postpress (e.g. finishing and binding) equipment. Often, printing equipment is created with general purpose capabilities to support a wide range of jobs types where control parameters govern the equipment's use for a specific job.

Historically a print order, which includes printable content and printing intent, would not be provided as a homogenous entity from a customer. Rather, printable content could be provided in a wide variety of formats and at varying times during the lifetime of the job. Printing intent could be communicated in different ways and often separately from the printable content. Typically, a printer's customer service representative would work with a customer to consolidate and refine the printing intent and printable content to match the capabilities of the printer's equipment prior to submitting the job for production processing.

With the advent of internet popularity, many printers have a desire to provide internet-enabled storefront portals to their printing operations. Through a storefront, a customer could automatically specify intent and content together so that a printing order is automatically submitted for production processing without the aid of a customer service representative. Some printing equipment vendors have disclosed or are providing storefront products capable of submitting complete print orders. The format of such a print order could take many forms but one standardized format, specified by the CIP4™ consortium, is the Job Description Format (JDF). A JDF print order could conform with the JDF Specification (current version 1.3, published Sep. 30, 2005 and available at http://www.cip4.org/documents/jdf_specifications/JDF1.3.pdf). JDF includes syntax for specifying printing intent along with references to printable content (e.g. PDF file(s)). One difficulty with JDF is that it produces relatively complex specifications that are difficult for users to read directly.

A printer could, for example, use storefront equipment to define different orderable product types (e.g. business card, invitation, brochure), each with numerous options specifiable by a customer. Thus, a print order could represent one of many possible (e.g. hundreds or thousands) specific printing intents. Production processing of a specific printing intent could be accomplished through one or more specific workflows (i.e. unique set of control parameters for each one of a specific sequence of processing steps on a specific set of printing equipment). Establishing the workflow could be accomplished manually or with some degree of automation. An automated process is preferred but providing a high degree of automation with sufficient flexibility and ease of use remains a challenge, as outlined below.

Some printing equipment can be configured for automated processing but typically the control parameters must be preconfigured in a template that is selected for a print order. Some printing equipment can be dynamically configured so that software program logic can dynamically establish control parameters for it. However, both of these approaches are problematic. The administrative workload in administering a large quantity of templates is cumbersome while the programming skills and costs required to dynamically configure the equipment is excessive for most printers.

The following paragraphs provide some examples of printing workflow automation that exist in the related art and their limitations with respect to the field of the invention.

One example is disclosed in U.S. Pat. No. 4,839,829, entitled “Automated Printing Controls System”, to Freedman. Freedman discloses a user, during submission of a print order, selecting a printing parameter design template or interactively entering printing parameters to create a new custom design template. This offers a choice between limited flexibility and manual configuration requiring the customer to know details of the printing processes.

Another example is disclosed in US patent publication 2004/0193465, entitled “Automated Workflow Assignment To Print Jobs”, to Sangroniz et al. Sangroniz discloses inserting printing workflow details into a job ticket (i.e. print order) based on comparing attributes of the print order with predefined criteria. A predefined criteria is associated with a job specification (i.e. template) for a predefined printing workflow. This offers flexibility for configuring many workflows for a variety of printing intents along with automation and without burdening the customer with details of the printing process. However, this can still lead to an unwieldy number of specific printing workflow job specifications required to match the range of printing intents. It may also be difficult for a printing firm to easily visualize the differences between similar workflows required for similar printing intents as this may require examining each parameter of each job specification.

Another example is disclosed in U.S. Pat. No. 6,380,951, entitled “Prepress Workflow Method and Program”, and U.S. Pat. No. 6,483,524, entitled “Prepress Workflow Method Using Raster Image Processor”, to Petchenkine et al. Petchenkine discloses creating pictorial printing workflow plans to enable a user to visualize a printing workflow. Petchenkine discloses creating a pictorial plan by linking prepress processing module icons in a design palette and configuring control parameters for each module to create a specific workflow. This provides a simple visual representation of a printing workflow plan but the plan cannot adapt to different printing intents without being manually reconfigured.

Another example is the Prinergy product, manufactured by Eastman Kodak Company. Prinergy is a printing workflow system providing a variety of workflow automation features used by printing firms employing offset, flexography, gravure and digital printing equipment. Current Prinergy features includes printing workflow automation that relies on preconfigured control parameters for a processing step. This includes both workflow job specifications and pictorial plans similar to the approaches described above. However, even with this range of methods available, Prinergy lacks the flexibility and ease-of-use that is required to support a wide range of printing intents.

As outlined above, state-of-the-art printing workflow systems still lack a suitable combination of flexibility and ease-of-use for automatically processing a wide variety of electronic print orders submitted by a printer's customers.

In order to more easily understand the improvements of the present invention, certain aspects of current Prinergy features are disclosed in more detail in reference to FIGS. 1A-1F. These figures illustrate some exemplary workflow processing steps along with a variety of manual and automated methods for performing those steps. The limitations outlined above will be apparent to one with ordinary skill in the art.

FIG. 1A depicts an exemplary job pages view 101 for a job in a Prinergy Graphic User Interface (GUI). Prinergy associates all information relating to a print order with a job. Jobs can be created manually or automatically through an API. Job pages view 101 provides one view of the information for a job. Input file pane 102 displays input files defining printable content for an order. These files could have been manually associated with the job using the GUI or could have been automatically associated with the job by a portal application. Printing intent (not shown) could also be associated with the job, based a JDF or other type of specification file, and could be browsed by a user or have relevant printing intent extracted for use in a processing step.

Process template pane 103 displays a set of preconfigured processing templates that can be applied to an input file. A processing template can include a single processing step or some sequence of processing steps. Refine templates convert input files from one format (e.g. PostScript, TIFF or others) into a set of digital master pages (one PDF page per file) having a predictable and print-ready format. A Prinergy user can refine an input file by selecting both the file and the template and manually activating the processing. Refining can also occur automatically by associating an input file folder with the template or by allowing a portal product to activate the refine process through an API.

Pages pane 104 depicts the set of digital master pages resulting from refining. Pages pane 104 depicts five distinct pages resulting from two input files. Page sets pane 105 depicts an ordering of the pages for further processing. The ordering can represent a reader ordering or an ordering defined by a product type, for example, which may not be apparent from the input files alone. Pages from pages pane 104 can be assigned to page positions in page sets pane 105 manually or automatically through an API.

FIG. 1B depicts an exemplary refine template editor 110. Each configuration tab 111A, 111B . . . 111J represents a lower-level processing step that is to be performed by the higher level refine processing step. Each configuration tab 111A, 111B . . . 111J can be opened to allow editing of control parameters for the processing step.

FIG. 1C depicts an exemplary job signatures view 120 for a job. This view can be used after pages have been refined and are ready to output. It depicts an imposition plans pane 121 which defines how the pages from a page set can be assigned to layouts for printing on one or more sheets of paper. An imposition plan can be manually associated with a job or automatically associated with the job through an API. The source of imposition plan information can be, for example, a separate imposition file supplied along with the input files, created or referenced based on customer instructions, or included in the printing intent of the print order using JDF stripping parameters or the like. Process templates pane 103 now depicts a range of output processing options that can be applied, including: loose page proofs of one or more pages, imposition proofs (e.g. prints or files) of one or more signatures (i.e. printed sheets), virtual proofs of pages or signatures for a monitor, and final output (e.g. printing plates) of one or more signatures. A Prinergy user can create output by selecting the pages or signatures along with the template and manually activating the processing or automatically through an API.

Multiple processing steps can be preconfigured in an end to end workflow as well. Process template pane 103 also depicts a Workflow process template which can sequence the high level processing steps upon submission of input files. Although this is more automated, the workflow plan is restricted in the type of input that will work and the nature of the processing performed.

FIG. 1D depicts an imposition proof output template editor 130. This editor includes output configuration tabs 131A, 131B . . . 131I representing a set of lower-level output processing steps. Tab 131I has been opened and depicts some of the detailed control parameters for production of JDF as part of the output. This JDF, along with associated content files, can be used, for example, to provide a detailed printing specification to a JDF-compliant printing device such as the NexPress digital printer manufactured by Eastman Kodak. JDF templates can be created using tools for specifying the printing device configuration (see FIG. 2). Alternatively, a printing device could provide an API to publish its capabilities and accept control parameters so that an application like a Prinergy template editor could define the controls directly. Thus, the result of Prinergy workflow can be a JDF file (or other form of processing specification) referencing processed content and specifying how to print that content on a digital printer. The output JDF file can optionally include additional printing intent details included in the original print order (e.g. customer name, delivery instructions).

FIG. 1E depicts an exemplary pictorial plan editor 140 providing an alternate method of predefining some or all of the processing steps of an automated workflow processing plan. This can achieve similar results as to those depicted in FIGS. 1A-D. However, it provides a user with the ability to create a variety of workflows from a toolbox of templates. It also provides visual representation that can simplify creation and maintenance of a custom workflow plan compared with configuring a series of templates.

Pictorial plans are created using plan editor 140 which includes an element pane 141 and a canvas pane 142. Element pane 141 depicts tabs, each defining predefined types of elements for use in creating a customer workflow. Element types include event types 143, flow types 144 and action types 145 (currently selected tab). Event types 143 can include any event type recognized by the Prinergy system, such as “print order submitted”, “file refined”, “imposed proof generated”, and the like. Elements can be associated with each other by establishing connections 146 which represent a flow of information from one element to another. Flow types 144 can filter information or conditionally branch based on information provided to them. Action types 145 can reference predefined functions provided through Prinergy APIs such as activating a predefined processing template or performing a low level step such as assigning pages or executing an operating system command and the like.

A customized pictorial plan can be configured by placing elements on canvas pane 142 and providing connections 146 between them to form a flow of control starting from an event 143. Elements can be configured with simple logic so that a dynamic flow of control can be established based on a context provided by the system. For example, the configuration editor for flow type 144A can include a palette of relevant parameters (e.g. product order type) from the context (e.g. job context) along with simple logic statements (e.g. assert “yes” if Job.Order.ProductType=“Invitation”) that enable a user with limited programming skills to easily configure conditional behavior for flow type 144A. In particular, Prinergy maintains a set of execution contexts which can include static and dynamic information. Exemplary contexts include system status, job contexts and event contexts. A job context provides access to all information associated with a job. This includes, for example, associated static information and dynamic information such as job status, the names of input files, the number of pages refined and their attributes (e.g. trim size, orientation). An event context records information about a type of event recognized by the system. This can include, for example, information about the type of event, the origin of the event, when the event occurred and any element associated with the event.

FIG. 1F depicts an exemplary final output template editor 150. Editor 150 includes output configuration tabs 151A-115D representing a set of lower-level output processing steps. Tab 151D has been opened and depicts some of the detailed control parameters for calibrating and screening rendered pixel information for a target printing device (e.g. platesetter). For example, different settings for screening parameters (e.g. feature size or screen ruling) can improve the quality of the printed result.

### SUMMARY OF THE INVENTION

The present invention provides an improvement over the prior art by providing a computerized editor and execution environment for pictorial workflow plans that can dynamically assign control parameters for processing steps based in part on the printing intent specified by a customer in a print order. This is a departure for some of the prior art outlined above. In relation to the Prinergy workflow system prior art, the invention represents more of an evolution, but one that maintains flexibility and simplicity despite a wide range of customizable printing intents that heretofore would have been difficult to manage.

One aspect of the invention includes integrating a storefront system with a workflow system so that print orders can be referenced in automated pictorial plans. Integrating a storefront system can include sharing product type definitions upon which print orders are based. For each product type, a print order schema is created which defines the type of printing intent information that a customer must supply as part of an order. The term schema relates to information describing the organization of data. For example, in database systems, tables of data have schemas that describe the nature of information that can be presented in the tables. Since a product type implies or results in the inclusion of additional printing intent information (e.g. page relevance and imposition) for the print order, the print order schema can be much simpler than a schema describing a complete printing intent. Having a simplified schema available in the static context for use by a pictorial plan makes the task of creating the pictorial plan simpler.

Another aspect of the invention includes making processing step control schemas available in the context for pictorial plans. This enables, for example, action elements to dynamically create a complete set of control parameters for a processing step based on the execution context. In one preferred embodiment this can include associating control schemas with preconfigured processing step templates so that specific control parameters can be overridden based on the execution context. In this manner, templates can be created for parameters that represent suitable defaults for a product type and the plan can be simplified to dynamically setting just the intent-related parameters.

Stated another way, and without limiting the scope of the invention, the invention can be characterized as a method for providing an automated printing workflow comprising:

creating a static context including a print order schema for specifying a printing intent and a control schema for specifying the control parameters of a print processing step;

creating a pictorial plan for automatically controlling a workflow wherein the pictorial plan is based upon the static context; and

automatically executing the pictorial plan in response to receiving a print order wherein the print order is based in part on the print order schema and wherein executing includes:
deriving an execution context based in part upon the submitted print order; and
dynamically generating at least one control parameter value based on the execution context.

### BRIEF DESCRIPTION OF THE DRAWINGS

FIGS. 1A-1F illustrate exemplary aspects of a representative prior art workflow system depicting various automation capabilities and their limitations with respect to the field of the invention;

FIG. 2 illustrates an exemplary control parameter template editor for a digital printer that corresponds to a control schema for the digital printer;

FIG. 3A is a functional block diagram illustrating an exemplary automated printing system according to one embodiment of the invention;

FIG. 3B is a functional block diagram illustrating an example of another level of detail of printing system according to one embodiment of the invention;

FIG. 3C is an exemplary data structure diagram illustrating system context according to one embodiment of the invention;

FIG. 4A is a data structure diagram illustrating an exemplary print order schema according to one embodiment of the invention;

FIGS. 4B-4J are illustrations of an exemplary printed invitation product type and the printable content associated with a printed invitation;

FIGS. 5A-5B are illustrations of exemplary imposition plans defined for use by pictorial plans; and

FIGS. 6A-6E are illustrations of portions of an exemplary pictorial plan for automated processing of a print order for an invitation product type.

### DETAILED DESCRIPTION OF THE INVENTION

The invention has been described in detail with particular reference to certain preferred embodiments thereof, but it will be understood that variations and modifications can be effected within the spirit and scope of the invention.

In one preferred embodiment of the invention, the Prinergy workflow product is adapted to include various aspects of the invention. For clarity, the remainder of the description will use the Prinergy product as an example of these aspects. However, one of ordinary skill in the art will appreciate that the aspects described and inherent in Prinergy can also apply to other embodiments.

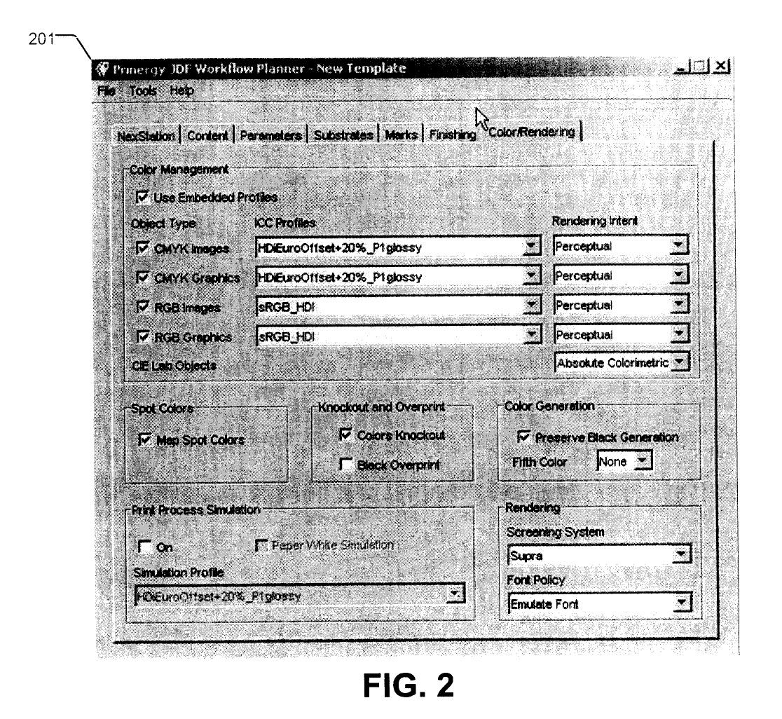

The first aspect involves making control schemas, for processing steps provided by various printing equipment, available to pictorial plans. FIG. 2 depicts an exemplary digital printer control editor 201 provided by a digital printer manufacturer. A variety of controls are illustrated, organized in different tabs, for creating a template to control processing of printable content in a NexPress digital printer. Editor 201 produces a control template in conformance with a JDF Specification. Each control parameter defined by editor 201 may be characterized by a name and value pair.

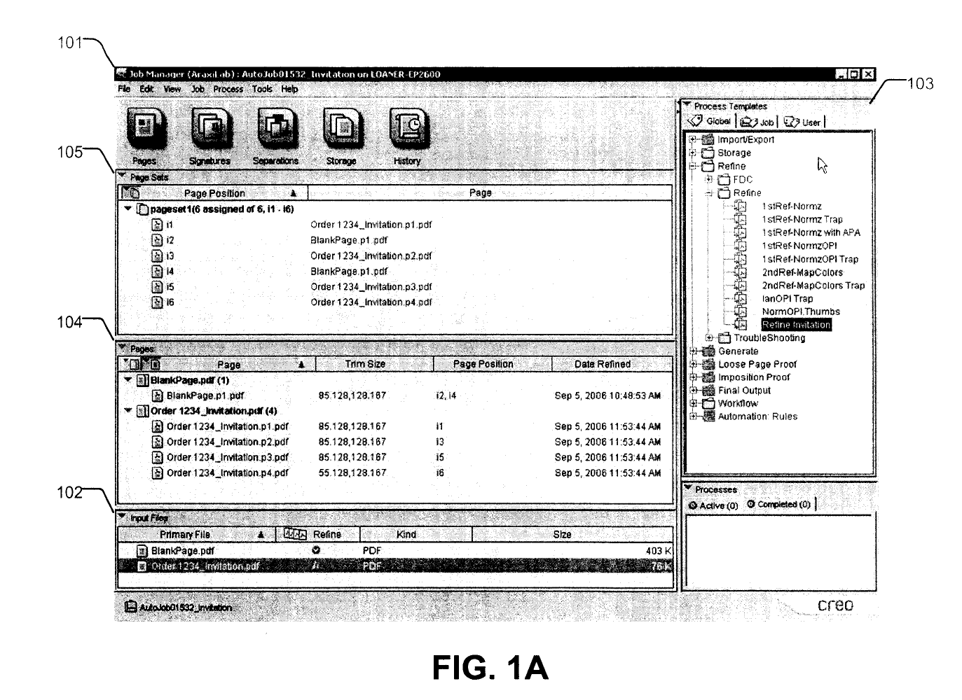

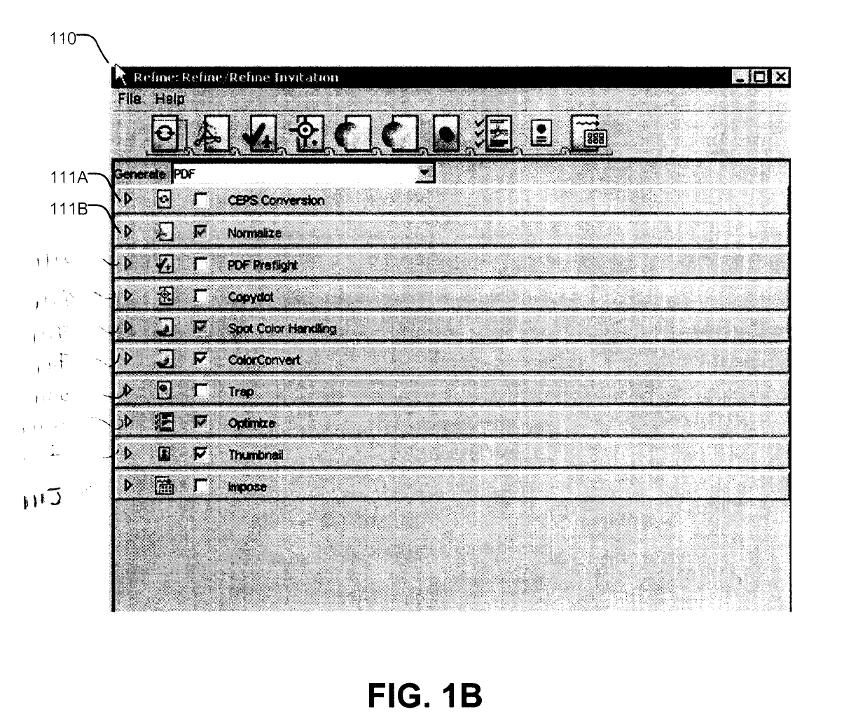

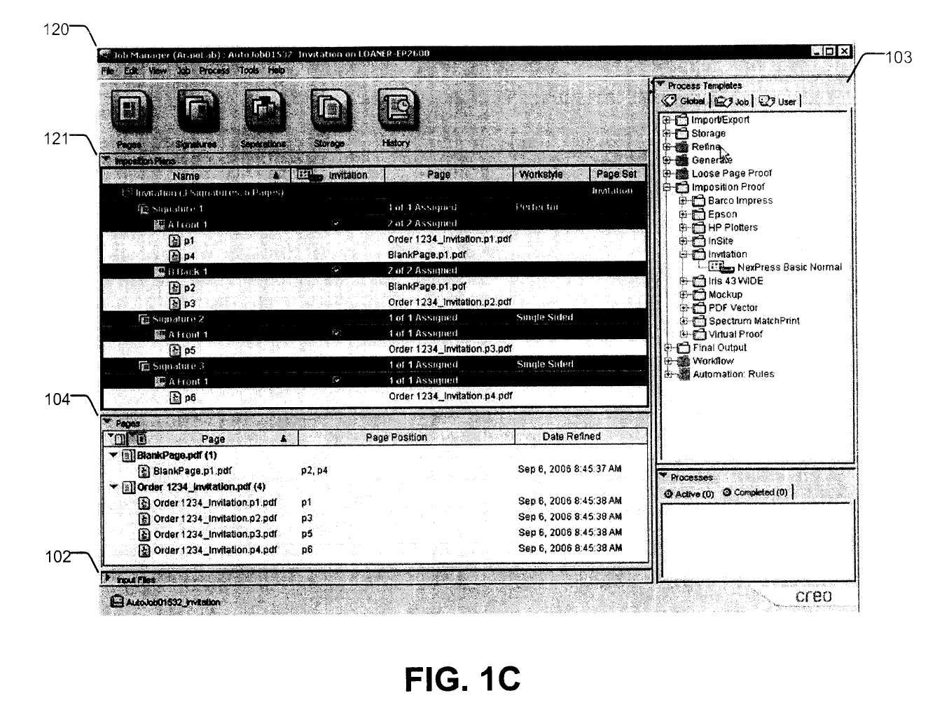

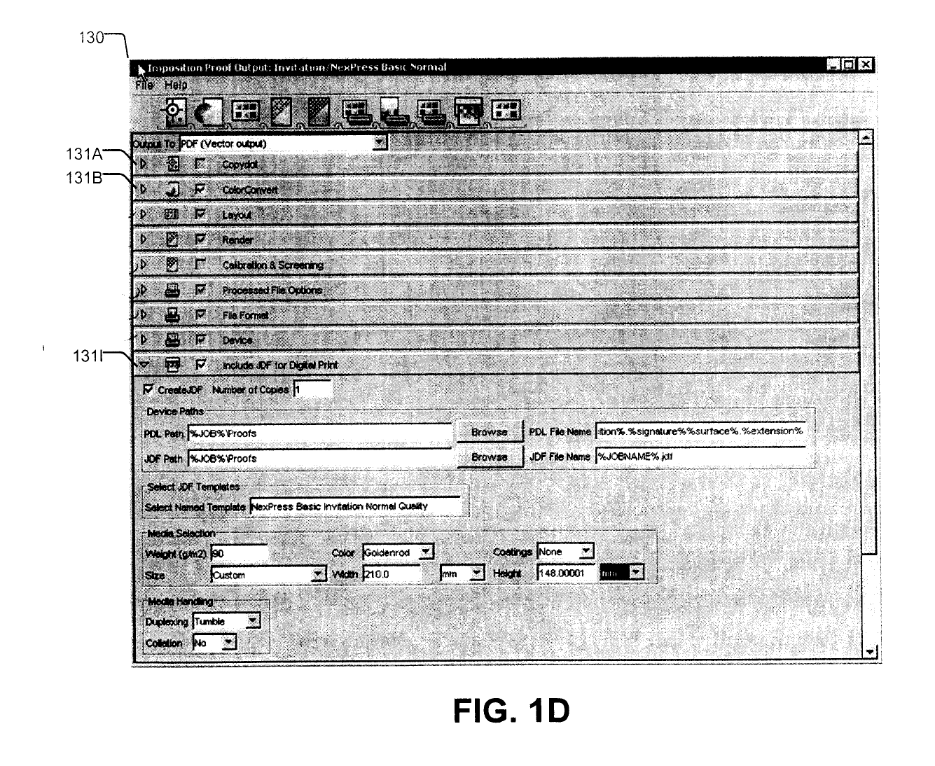

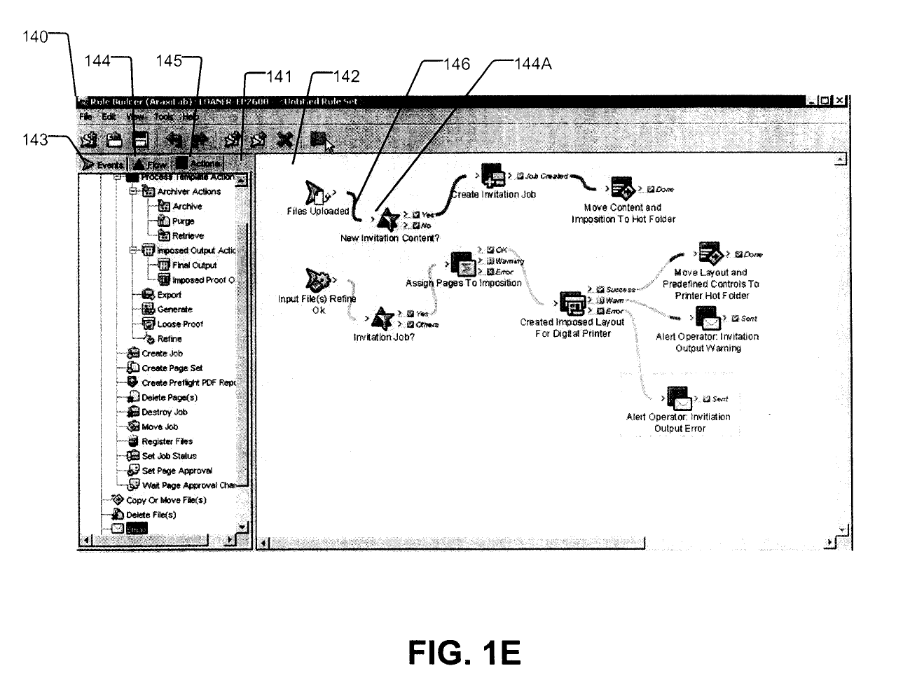

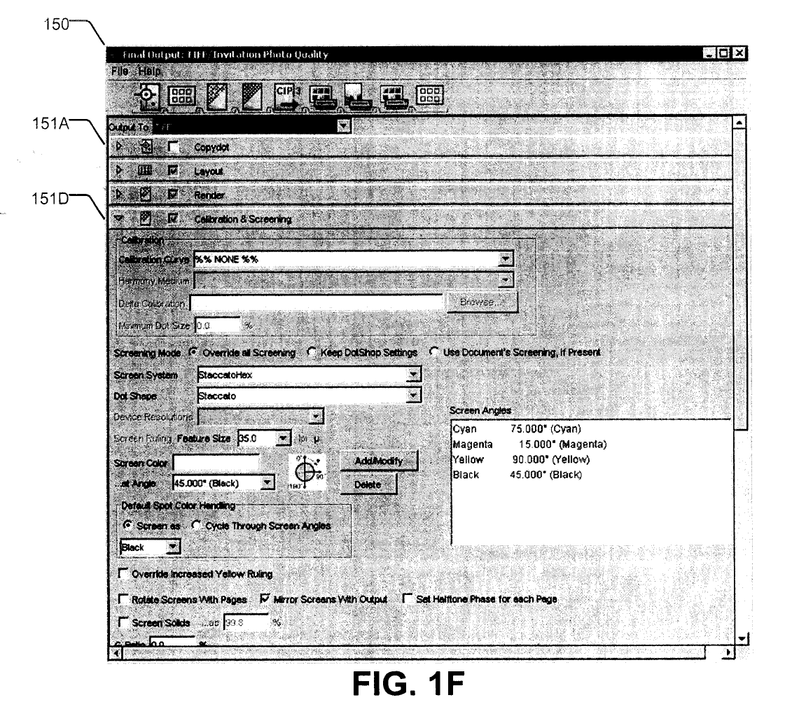

The complete set of control parameters presented by editor 201 can be represented by a control schema including information about the parameter names, data types and rules governing the values (e.g. significant figures, dependencies and the like). Alternatively, a control schema can be simplified to a subset of control parameters that are of interest to users of a pictorial plan editor. Prinergy can use such a simplified control schema to override certain parameters in a preconfigured JDF template or other type of specification, for example. As another example, a complete control schema could be used to generate all new parameters. Regardless, control parameters could then be delivered to a NexPress digital printer. Similarly, as illustrated in FIG. 1F, control schemas can be made available to pictorial plans for internally-provided Prinergy processing steps. Other external equipment can be similarly controlled through acquisition of a control schema and a means for communicating the control parameters to the equipment.

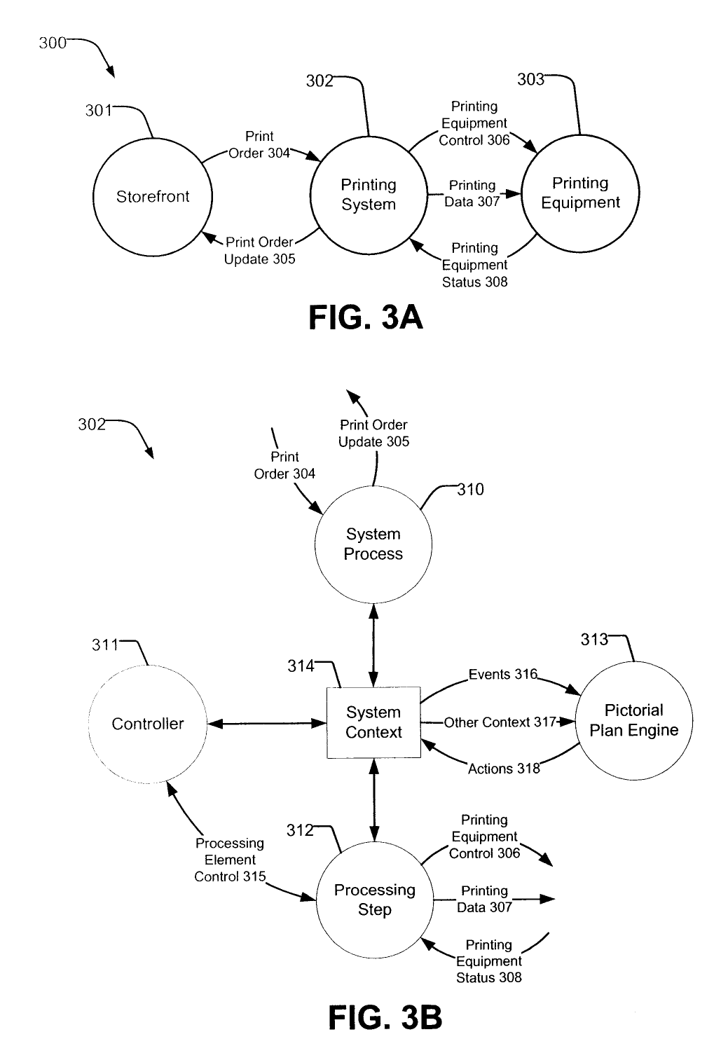

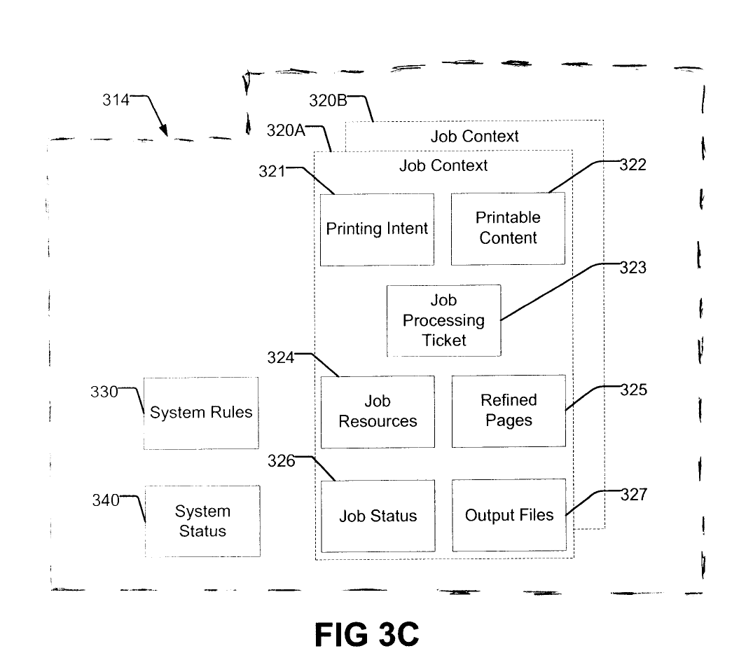

FIG. 3A is a functional block diagram illustrating an exemplary automated printing system 300 according to one embodiment of the invention. Storefront 301 provides an internet or other communication portal to a printer's customer for placing orders and tracking their status. In one preferred embodiment, storefront 301 is a web-server based product integrated with printing system 302 so that print orders 304 can be received through a web browser from a customer and print order updates 305 (e.g. problems, status of processing steps, customer approval) can be communicated back to the customer. Printing system 302 provides printing management services that can include control of printing equipment 303.

Different configurations of equipment can embody these functional blocks. For example, one piece of equipment can provide both storefront 301 and printing system 302 blocks. As another example, printing system 302 can be solely a controller and utilize separate printing equipment 303 for all of the processing steps. Or, as in the case of Prinergy, printing system 302 can provide some of the processing steps internally. Regardless of the configuration, the control portion of printing system 302 interacts with printing equipment 303 by obtaining printing equipment status 308, which may include, for example, control schemas and processing step status. Activation of printing equipment 303 occurs by providing printing equipment control 306 along with printing data 307, if required. File transfer, messaging, APIs and the like are all examples of means for printing system 302 to communicate with printing equipment 303 and storefront 301.

FIG. 3B is a functional block diagram illustrating an example of another level of detail of printing system 302 according to one embodiment of the invention. System process 310 can represent any number of functions that are necessary for system operation and are represented here by this one function for clarity. As an example, one system function may provide communication services with storefront 301. In doing so, one embodiment of system process 310 can store print order 304 in system context 314 and provide print order updates from system context 314 as they become available. Other embodiments can include, for example, GUI functions, scheduling functions and maintenance functions. System context 314 is described in more detail with reference to FIG. 3C, but in essence it provides for storage of static and dynamic information that may need to be shared amongst functions of printing system 302.

Controller 311 represents a class of higher-level functions that can activate lower-level processing steps 312 for printing system 302. Controller 311 activates a processing step by providing it with control parameters 315. An exemplary controller 311 may be a function that can sequence a series of processing steps 312 based on a refine template, illustrated in FIG. 1B, or an output template, illustrated in FIG. 1D. Thus, controller 311 could be activated through system process 310 by a user interacting with a GUI. As another example, controller 311 could be activated by a pictorial plan actions 318 reported through system context 314. As another example, controller 311 may provide an API (Application Programming Interface, e.g. a set of program function or procedure calls that can be made by an external application) to allow other functions (e.g. storefront 301) to activate a processing step 312 on its behalf.

Processing step 312 represents all processing steps that can be performed by printing system 302 or externally by printing equipment 303. In the latter case, processing step 312 behaves as a proxy for an external processing step. Processing step 312 obtains additional information that it may require (e.g. printable content) from system context 314. Processing step 312 can provide information related to the processing it performs back to system context 314. So, for example, processing step 312 can be an internal refine function and record the progress of each refining step in the system context for historical reference or use as an event in a pictorial plan.

Pictorial plan engine 313 represents an environment for execution of a pictorial plan. It takes events 316 as input and requests actions 318 to be performed by system process 310, controller 311 or processing step 312. It requests actions 318 on the basis of events 316 applied against other context 317. Other context 317 can include pictorial plan element types, associated logic, and connections configured through a pictorial plan editor, similar to one depicted in FIG. 1E. Other context 317 can also include other static information such as processing step templates, control schemas and the like from system context 314. Other context 317 can also include other dynamic information from system context 314.

FIG. 3C is a data structure diagram illustrating an exemplary system context 314 according to one embodiment of the invention. System context 314 can include system rules 330, system status 340, and one or more job contexts 320. System rules 330 can include pictorial plan definitions, control schemas for processing steps, control parameter templates for processing steps, print order schemas, and other statically defined information that can be used to control processing in printing system 302. System status 340 can include dynamic system information that has relevance for printing system 302.

Job context 320A, 320B includes printing intent 321 and printable content 322 derived from print order 304 or otherwise supplied automatically or manually. Printing intent 321 can include a simplified printing intent for use in pictorial plans. Simplified printing intent can be derived by examining print order 304 to extract parameters or synthesize simplified parameters from print order 304 based on a print order schema. Printing intent 321 can also include other intent, such as a printable product type, imposition information, delivery information and the like. Printable content 322 can include, for example, input files (e.g. PostScript, PDF, TIFF) specifying one or more page images or references to content accessible on another system.

Job resources 324 can, for example, include or reference processing step templates, page sets, imposition plans or other information necessary for completing processing steps. Refined pages 325 can, for example, include one or more digital master pages produced from printable content 322 by one or more prepress processing steps. Job status 326 can, for example, include dynamic information having relevance in job context 320. The dynamic information can, for example, include information also present in system status 340 but the information is at least associated with job context 320. Output files 327 can, for example, include information produced by a processing step for delivery to printing equipment 303. This can, for example, include imposed PDF pages, rendered pages, control parameters in JDF and other forms of output.

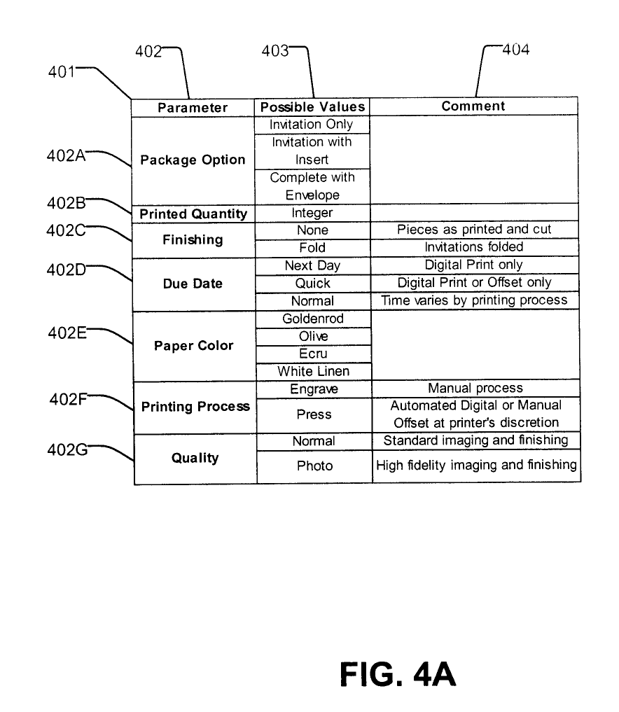

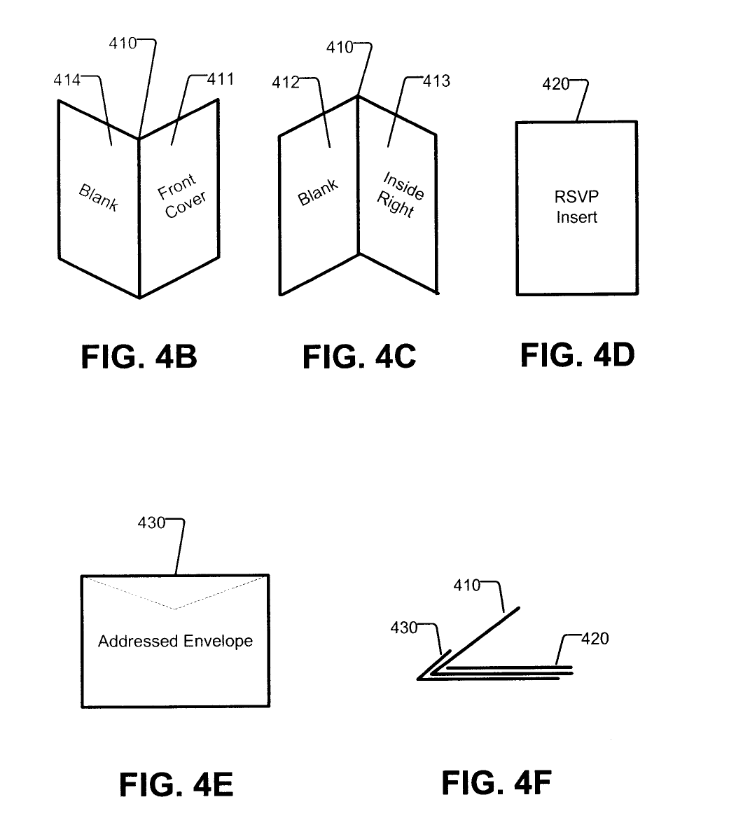

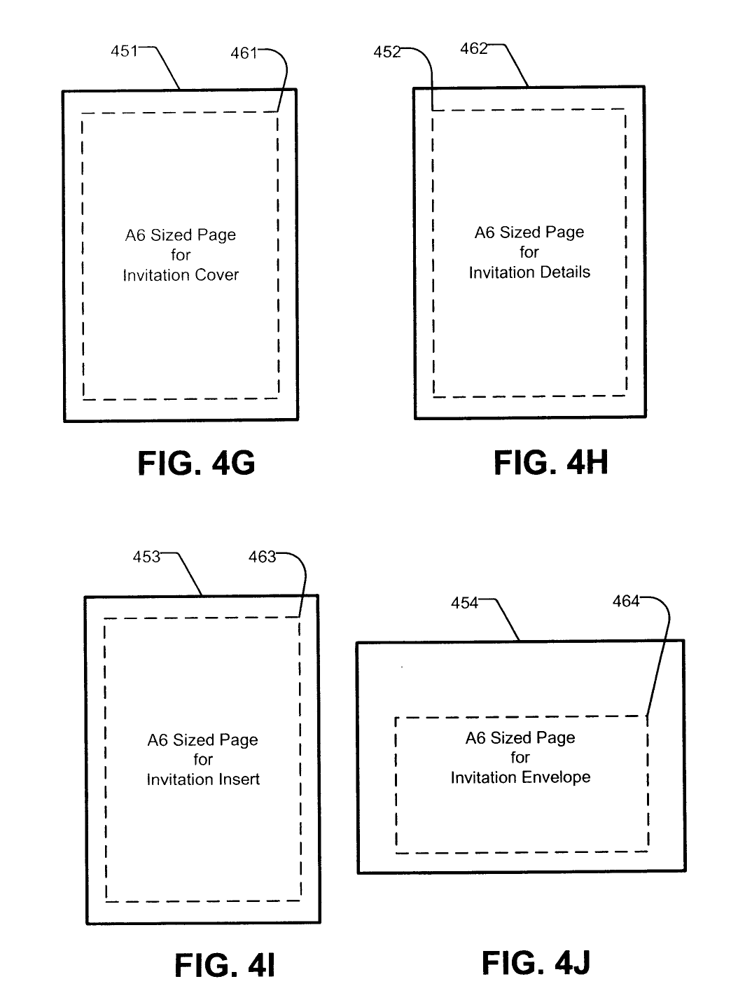

FIG. 4A is a data structure diagram illustrating an exemplary print order schema 401 according to one embodiment of the invention. It can be used to further illustrate aspects of the invention. Print order schema 401 can be associated with an invitation product type configured for storefront 301 which defines a set of intent parameters 402, 402A-402G whose values are supplied by a customer as part of print order 304. For each intent parameter 402, 402A-402G, a corresponding set of possible values 403 is specified. A comment 404 is provided for some parameters 402, 402A-402G to facilitate a better understanding of their meaning and use. Note that other printing intent values, such as billing, delivery and other customer information is not defined by print order schema 401 since, for the purposes of this example, that information isn't relevant to configuration of a pictorial plan. This simplified schema eases the task of creating a pictorial plan by reducing information presented to the user. The omitted information can still be included in print order 304 and stored as part of printing intent 321 for use in other ways.

The exemplary invitation product type has been configured to allow three basic variants, identified by the package option parameter 402A. The three option packages include a basic invitation, a basic invitation with an RSVP insert and a complete invitation including an addressed envelope for the insert.

In our example, due date 402D is one parameter that dynamically affects how an invitation will be printed. For example, a printer could determine that next day delivery mandates the use of a digital printer whereas quick delivery could employ either digital printing for smaller quantities or offset printing for larger quantities. Finally, normal delivery could mandate the use of the lower cost offset printing. This type of plan enables a printer to trade-off time for cost in a pragmatic way and offer more dynamic pricing models.

Quality 402G is another parameter that dynamically affects processing steps in the example since various processing steps may require different controls based on differences in values for this parameter. For example, selecting normal quality can mandate the use of default settings from a template whereas photo quality may require overrides for screening, rendering, color matching or other processing step controls. To further complicate matters, the processing steps affected by quality 402G can vary based on the printing process determined by due date 402D or other intent parameters 402.

FIGS. 4B-4J are illustrations of an exemplary printed invitation product type and the printable content associated with the printed invitation. The information portrayed in these figures can represent implied or directly included information in printing intent 321 and may be presented to a storefront user pictorially or in some other way to ensure that the user agrees with this intent.

FIGS. 4B-4C illustrate the front and back sides of a basic invitation 410 to be folded along a vertical fold line. Basic invitation 410 includes four pages of content, including front cover 411, back cover 414 (blank for the example product type), inside right 413, and inside left 412 (also blank). FIG. 4D illustrates an optional RSVP insert 420 as a single piece of paper printed only on one surface. FIG. 4E illustrates an optional RSVP envelope 430 with a return address printed on the front surface. FIG. 4F illustrates an optional finishing arrangement for each copy of a complete package option that could be performed manually or by postpress equipment.

FIGS. 4G-4J illustrate the intended format of printable content to be supplied by the customer for each of the previously illustrated package pieces. Similar to above, this intent may be presented to a storefront user in some manner and may be included in printing intent 321. Cover page size 451 is illustrated as an A6 page for printing on front cover 411. Cover page trim size 461 is illustrated as having a smaller dimension (e.g. 10 mm on each side) than front cover page size 451. Similarly, page sizes 452-454 and trim sizes 462-464 are illustrated for content to be printed on items referenced by numerals 413, 420 and 430 respectively. For a basic invitation, a customer need only provide page content for front cover 411 and inside right 413.

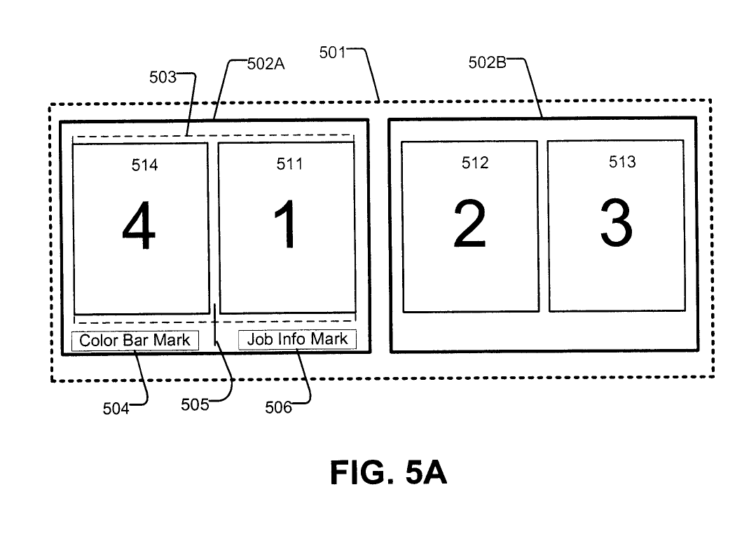

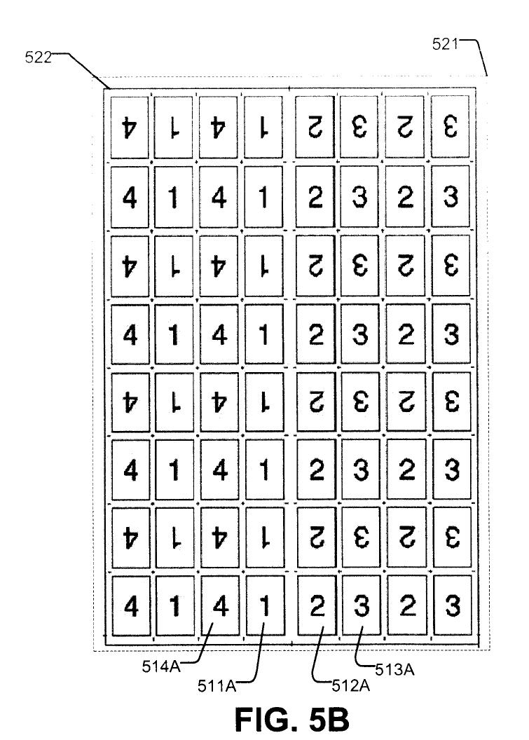

As described in the background, processing of printable content for printing usually requires some form of layout using an imposition plan. FIGS. 5A-5B are illustrations of two possible imposition plans defined for use by an exemplary pictorial plan. FIG. 5A illustrates a so-called 1-up imposition suitable for printing a basic invitation 410 on A5 paper using a digital printer. FIG. 5B illustrates a so-called 32-up imposition for printing a basic invitation 410 on A0 paper using an offset printer.

The imposition can be included in print order 304 or be implied or referenced by it. FIG. 5A illustrates an exemplary digital print basic invitation signature 501. Signature 501 defines a front side surface 502A and a back side surface 502B of an A5 sheet of paper for a saddle stitch imposition style. Page set page placeholders 511-514 depict the placement of refined pages (including blank pages). Imposition marks 503-506 are illustrated to respectively facilitate trimming, color monitoring, folding and identification. Imposition can be performed by the printing system or in some cases by the digital printer. For our example, assume that printing system 302 produces an imposed PDF file as output based on signature 501 and that some digital printers can be further cost-optimized themselves by producing a 2-up layout from a signature 501 on A4 paper.

Exemplary offset basic invitation signature 521, illustrated in FIG. 5B, is based on a work and turn imposition style where the same layout is printed on both surfaces 522 of the paper after turning the paper over on its long axis. With this imposition, every pair of page positions (e.g. placeholders 511A and 514A or 512A and 513A, along with their reverse-side printed versions of 512A and 513A or 511A and 514A) corresponds to a 1-up of basic invitation 410 which can subsequently be realized by folding and trimming the A0 sheet of paper.

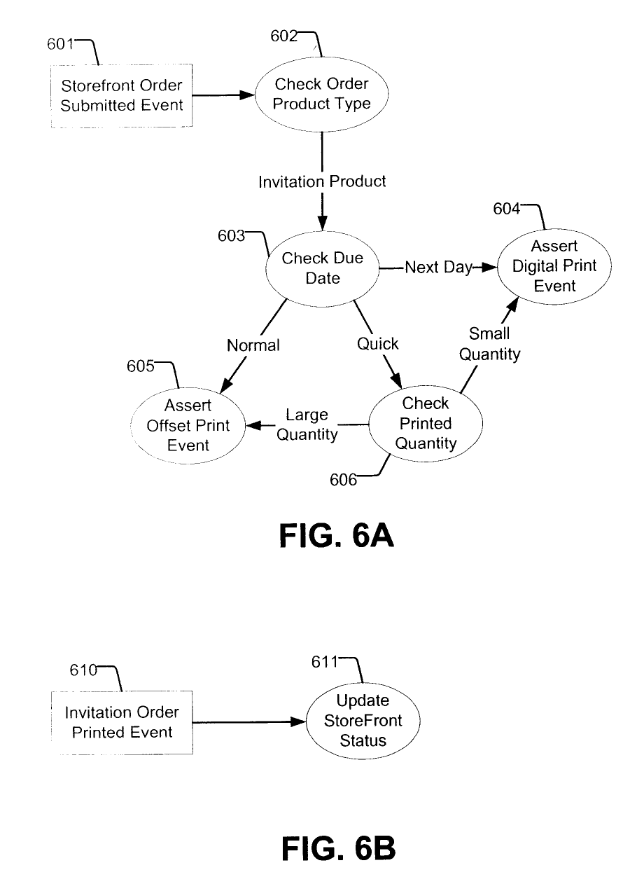

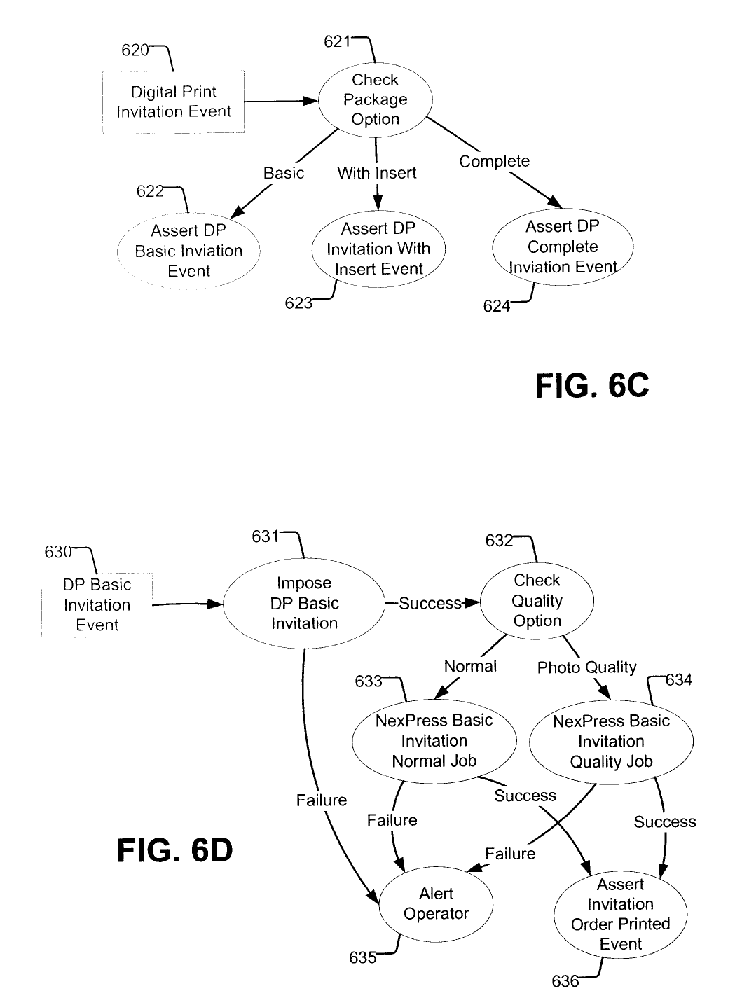

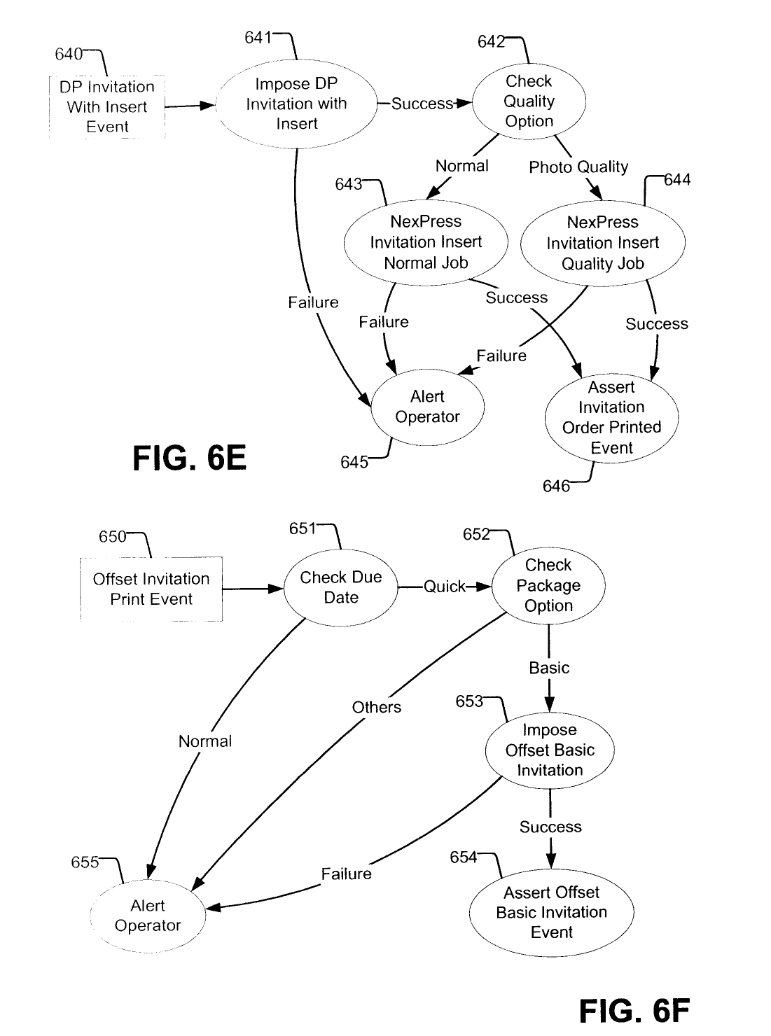

FIGS. 6A-6E are illustrations of portions of an exemplary pictorial plan for automated processing of a print order conforming with print order schema 401. The pictorial plan includes dynamically generating some control parameters for processing steps having control schemas represented by FIGS. 1D, 1F and 2. According to one embodiment of the invention a plan can be created as monolithic pictures or as a set of pictures, each representing a portion of the plan, and linked together (e.g. by common events). Breaking up the plan into pieces can simplify their conception, creation and maintenance.

FIG. 6A illustrates an exemplary first portion of a dynamic pictorial plan for basic invitation 410. The plan begins upon receipt of storefront order submitted event 601. Events of this type can be recognized by printing system 302, for example, after storefront 301 has already performed the following steps to confirm the viability and customer approval for the order:
1. Creating a new job and job context 320 in printing system 302 for the order.
2. Uploading files associated with the print order including printing intent 321 and printable content 322 for the new job. An exemplary version of JDF syntax corresponding to an invitation print order is included in Appendix A.
3. Refining printable content 322 using a preconfigured template to provide information suitable to confirm that content conforms to expectations for the product type (e.g. the number of pages, page size, trim size, image resolution).
4. Deriving a simplified printing intent in the execution context for pictorial plans associated with the job based on information in the print order and the print order schema preconfigured for the product type.
5. Creating a page set and assigning refined pages 325 to the page set.
6. Importing preconfigured digital print and offset imposition plans and associating them with the page set.
7. Approval by the customer of a visual mockup of the printed basic invitation based on refined pages 325.
8. Changing the status of the job to “submitted” which triggers event 601.
   In other embodiments, some or all of the processing steps could also be included as one or more common pictorial plan portions shared among many pictorial plan. For example, a common plan portion could be created for the first four steps and an invitation-specific portion could be created for the last four steps. Regardless of how event 601 is generated, it can produce an event context which includes the product type parameter associated with the order.

FIG. 6A illustrates event 601 connected to check order product type action 602, which could be a user-defined action (or could be embodied as a flow element as well) that contains a single logic statement that checks whether the product type parameter, from the event context, has a value corresponding to an invitation associated with print order schema 401. If the product type is not an invitation, the flow of control ends for this plan. Other plans for other product types may be evaluated if they are configured to utilize event 601. If event 601 is for an invitation product type, control flows to check due date action 603.

Action 603 performs a similar simple logic check on the value of the intent parameter corresponding to due date 402D. Control then flows to one of three actions 604-606, depending on that logic and as depicted in FIG. 6A. For “next day” delivery, the plan performs assert digital print event action 604 which generates an event in the execution context for the job which can then be evaluated against other plans or portions of plans associated with that job.

For “quick” delivery, check printed quantity action 606 performs a similar simple logic check on the value of the intent parameter corresponding to printed quantity 402B. If the printed quantity parameter is larger than some preconfigured amount, control flows to assert offset print event 605 and then terminates. Otherwise, for a smaller amount, control flows to assert digital print event action 604. In both cases, events are generated in the execution context of the job for consumption by other portions of this plan.

FIG. 6B illustrates an exemplary final portion of the pictorial plan for providing an example of print order update 305 to storefront 301. In this example, invitation order printed event 610 is assumed to be generated by some other portion of the plan and is the trigger for user-defined update storefront status action 611. Action 611 can, for example, use a storefront 301 API to communicate the date, time, quantity printed and other job information (e.g. delivery information if available) to storefront 301.

FIGS. 6C-6E illustrates exemplary digital print portions of the invitation plan. FIG. 6C illustrates action elements 621-624 for distinguishing between the different package options defined by parameter 402A. For a “basic invitation” package, DP basic invitation event 630 is asserted and control flows to FIG. 6D.

Impose DP basic invitation action 631 receives control flow from DP basic invitation event and calls a system function to associate signature 501 with the page set already created for the job. If this function is successful control flows to check quality option action 632. Otherwise, control flows to alert operator action 635, where generation of an email with details of the failure can be accomplished through another system function. Action 635 effectively ends the automated processing of the job until an operator corrects the problem and generates a manual event to resume automated processing or performs the remainder of the processing through some combination of manual or automated means.

Action 632 checks the value of intent parameter corresponding to quality 402G. For “photo” quality, control flows to NexPress basic invitation quality job action 634.

Action 634 can include, for example, simple logic for producing JDF output for a NexPress printing which is based on a predefined control parameter template including at least one parameter that is dynamically overridden based on the simplified printing intent. For example, action 634 first can first call a system function that merges a preconfigured NexPress control template, exemplified in FIG. 2, to merge a set of override values and produce a new temporary template. The override values can include at least a screening parameter value. The screening parameter can be assigned by logic of action 634 from available screening parameters, selected from the NexPress control parameter schema, to a value that is suitable for “photo” quality printing.

Action 634 can then call, for example, a system function that activates a predefined imposed output template, exemplified in FIG. 1D, with a set of override values for selected parameters. The override parameters can include at least a printed quantity. The printed quantity can be calculated using simple logic involving the printed quantity from the simplified printing intent and the layout parameter (e.g. 1-up or 2-up) prescribed by the NexPress control template. Activating the template causes the NexPress to receive and print the job specified by the control template and associated 1-up imposition. If action 634 is successful, control flows to assert invitation order printed event 635 and control eventually flows back to FIG. 6B.

For “normal” quality, action 633 is performed and can be configured similar to action 634 except it can rely on default parameters for the NexPress control template. One can appreciate that more complex action logic can be created that reduces the number of actions and connections. However, some of the benefits of the pictorial representation may be diminished. Thus, plans can be flexibly configured according to the user's skills and preferences.

FIG. 6E illustrates an exemplary plan for digitally printing an invitation with an insert. This can be patterned after the example of FIG. 6D but the actions will differ in terms of an additional signature and a more complex control parameter template (e.g. specifying a two part job). As illustrated in FIG. 6E, DP Invitation with Insert Event 640 flows to Impose DP Invitation with Insert 641. Success provides for Check Quality Option 642. Based on Normal or Photo Quality and failure or success, the flow can go to NexPress Invitation Insert Normal Job 643, NexPress Invitation Insert Quality Job 644, Alter Operator 645 or Assert Invention Order Printed Event 646.

FIG. 6F illustrates an exemplary plan for offset printing of an invitation. In this plan, automated processing occurs only if “quick” delivery of a “basic invitation” package is specified in the printing intent. In that case, assert offset basic invitation event 654 is asserted which can, through another plan portion (not shown, but similar to FIG. 6D) produce a 32-up offset configuration corresponding to FIG. 5B and activating a final output template similar to FIG. 1F with dynamically generated screening parameter values based on the value of the quality parameter 402G. In all other cases, an operator is alerted to either handle package options that can't easily be automated or handle problems. As illustrated in FIG. 6F, Offset Invitation Print Event 650 flows to Check Due Date 651. Quick provides for Check Package Option 652, Basic provides for Impose Offset Basic Invitation 653 and Success provides for Assert Offset Basic Invitation Event 654. Check Due Date 651 (Normal), Check Package Option 652 (Others), and Impose Offset Basic Invitation 653 (Failure) provides for Alert Operator 655.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, hard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

APPENDIX A
The following formatted text is an exemplary content for a JDF file
corresponding to print order 304 for an invitation product type.

-<JDF Version=“1.3” ID=“ID0645980BD5D31F4890FF7C09BAEC0439”
Type=“Product” Status=“Waiting”
kodak:ProductId=“5C20BFD1FC8AA941A8A6FE215B8FAD29”
kodak:JobId=“2F3A02A32F3A02A32F3A02A332605725”
kodak:ProductName=“Invitation” kodak:ProductDescription=“Inviting”
kodak:ProductCategory=“0D05D7FD3B72704E98E64A3ECE19ED08”
xsi:schemaLocation=“http://www.CIP4.org/JDFSchema_1_1
http://www.cip4.org/Schema/JDFSchema_1_3/JDF.xsd”
kodak:OrderNumber=“34” kodak:TotalCost=“$0.00”>
-<AuditPool>
<Created AgentName=“Kodak InSite” AgentVersion=“5.0.0.2243”
ID=“IDE039EC63D469964485672EDE736F74C6”
TimeStamp=“2006-09-
08T10:24:07Z”/>
</AuditPool>
-<JDF ID=“IDD6CBC36B625F8D4CB9ACD3750F4BB57D”
Type=“Product”
Status=“Waiting” DescriptiveName=“Content”>
-<AuditPool>
<Created AgentName=“Kodak InSite” AgentVersion=“5.0.0.2243”
ID=“ID626B72AC9D4FFC4086936A0FBCEDD680”
TimeStamp=“2006-09-
08T10:24:07Z”/>
</AuditPool>
<kodak:SourceElement
DatabaseID=“1EED5DAE286C344C9BF0288F58C078AB”/>
-<ResourcePool>
-<ArtDeliveryIntent ID=“IDB429EF7F8030A046AC282DCEADA0C426”
Class=“Intent” Status=“Available”>
<ArtDelivery kodak:NumberOfPages=“4”/>
</ArtDeliveryIntent>
</ResourcePool>
-<ResourceLinkPool>
<BindingIntentLink rRef=
“IDB429EF7F8030A046AC282DCEADA0C426”
Usage=“Input”/>
</ResourceLinkPool>
</JDF>
-<JDF ID=“ID55528DE605DA4043BDEB7BCD2B2E10CE”
Type=“Product”
Status=“Waiting” DescriptiveName=“Cover”>
-<AuditPool>
<Created AgentName=“Kodak InSite” AgentVersion=“5.0.0.2243”
ID=“ID2B8D40CEE10A6341A8CA125FC71515FE”
TimeStamp=“2006-09-
08T10:24:07Z”/>
</AuditPool>
-<ResourcePool>
-<ArtDeliveryIntent ID=“ID9F00DEC0FC6ED141A613B83BABA33B0F”
Class=“Intent” Status=“Available”>
<ArtDelivery kodak:NumberOfPages=“0”/>
</ArtDeliveryIntent>
</ResourcePool>
-<ResourceLinkPool>
<BindingIntentLink rRef=
“ID9F00DEC0FC6ED141A613B83BABA33B0F”
Usage=“Input”/>
</ResourceLinkPool>
</JDF>
-<ResourcePool>
<Component ID=“OutputComponent”
Class=“Quantity” Status=“Unavailable”
ComponentType=“FinalProduct” DescriptiveName=“Product”/>
<Component ID=“ID1F3861048C7E9A4CB34889D84F638CAC”
Class=“Quantity” Status=“Unavailable” ComponentType=“PartialProduct”
DescriptiveName=“General”/>
</ResourcePool>
-<ResourceLinkPool>
<ComponentLink rRef=“OutputComponent”
Usage=“Output” Amount=“500”/>
<ComponentLink rRef=“ID1F3861048C7E9A4CB34889D84F638CAC”
Usage=“Input” Amount=“500”/>
</ResourceLinkPool>
-<JDF ID=“ID4ECF1FA9483C5241AE0721A8762ED9E4”
Type=“Product”
Status=“Waiting” DescriptiveName=“General”>
-<AuditPool>
<Created AgentName=“Kodak InSite” AgentVersion=“5.0.0.2243”
ID=“IDAA2C4873A9A8184881101E515576BE0A”
TimeStamp=“2006-09-
08T10:24:08Z”/>
</AuditPool>
-<ResourcePool>
-<ArtDeliveryIntent ID=“IDAE61EBCA82F9F740B097806CF7CA2727”
Class=“Intent” Status=“Available”>
<ArtDelivery kodak:NumberOfPages=“4”/>
</ArtDeliveryIntent>
-<kodak:CustomIntent ID=
“IDC2DCF456CEC1D24781EFCD2816F64EDB”
Class=“Intent” Status=“Available”>
<kodak:PackageOption Value=“InvitationOnly”/>
<kodak:Quality Value=“Normal”/>
<kodak:PrintingProcess Value=“LetterPress”/>
<kodak:DueDate Value=“NextDay”/>
<kodak:Finishing Value=“Fold”/>
<kodak:PaperColor Value=“WhiteLinen”/>
</kodak:CustomIntent>
</ResourcePool>
-<ResourceLinkPool>
<BindingIntentLink rRef=
“IDAE61EBCA82F9F740B097806CF7CA2727”
Usage=“Input”/>
<ComponentLink rRef=“ID1F3861048C7E9A4CB34889D84F638CAC”
Usage=“Output”/>
</ResourceLinkPool>
</JDF>
</JDF>

The invention has been described in detail with particular reference to certain preferred embodiments thereof, but it will be understood that variations and modifications can be effected within the spirit and scope of the invention.

### PARTS LIST

101 Job pages view
102 Input file pane
103 Process template pane
104 Pages pane
105 Page sets pane
110 Refine template editor
111A-111J Refine configuration tab
120 Job signatures view
121 Imposition plans pane
131A-131I Proof output configuration tab
140 Pictorial plan editor
141 Element pane
142 Canvas pane
143 Event type
144 Flow type
145 Action type
150 Final output template editor
151A-151D Final output configuration tab
201 Digital printer control editor
300 Automated printing system
301 Storefront
302 Printing system
303 Printing equipment
304 Print order
305 Print order update
306 Printing equipment control
307 Printing data
308 Printing equipment status
310 System process
311 Controller
312 Processing step
313 Pictorial plan engine
314 System context
315 Processing element control
316 Event
317 Other Context
318 Action
320 Job context
321 Printing intent
322 Printable content
323 Job processing ticket
324 Job resources
325 Refined pages
326 Job status
327 Output files
330 System rules
340 System status
401 Print order schema
402, 402A-402G Intent parameter
403 Possible intent parameter value
404 Intent parameter comment
410 Basic invitation
411 Invitation front cover
412 Invitation inside left
413 Invitation inside right
414 Invitation back cover
420 RSVP insert
430 RSVP envelope
451 Invitation cover page size
452 Invitation inside right page size
453 RSVP insert page size
454 RSVP envelope page size
461 Invitation cover trim size
462 Invitation inside right trim size
463 RSVP insert trim size
464 RSVP envelope trim size
501 Digital print basic invitation signature
502A, 502B Digital print basic invitation signature surface
503 Trim imposition mark
504 Color imposition mark
505 Fold imposition mark
506 Job information mark
511A Page placeholder 1
512A Page placeholder 2
513A Page placeholder 3
514A Page placeholder 4
521 Offset basic invitation signature
522 Offset basic invitation signature surface
601 Storefront order submitted event
602 Check order product type action
603 Check due date action
604 Assert digital print event action
605 Assert offset print event action
606 Check printed quantity action
610 Invitation order printed event
611 Update storefront status action
620 Digital print invitation event
621 Check package option action
622 Assert DP basic invitation event action
623 Assert DP invitation with insert event action
624 Assert DP complete invitation event action
630 DP basic invitation event
631 Impose DP basic invitation action
632 Check quality option action
633 NexPress basic invitation normal job action
634 NexPress basic invitation quality job action
635 Alert operator action
636 Assert invitation order printed event action
640 DP invitation with insert event
641 Impose DP invitation with insert action
642 Check quality option action
643 NexPress invitation insert normal job action
644 NexPress invitation insert quality job action
645 Alert operator action
646 Assert invitation order printed event action
650 Offset invitation print event
651 Check due date action
652 Check package option action
653 Impose offset basic invitation action
654 Assert offset basic invitation event action
655 Alert operator action

1. A method for providing an automated printing workflow, the method comprising:
creating a static context including a print order schema for specifying a printing intent and a control schema for specifying control parameters of a print processing step;
creating a pictorial plan for automatically controlling a workflow, wherein the pictorial plan is based upon the static context; and
automatically executing the pictorial plan in response to receiving a print order, wherein the print order is based in part on the print order schema and wherein executing includes:
deriving an execution context based in part upon the submitted print order; and
dynamically generating at least one control parameter value based on the execution context.

2. A method according to claim 1, wherein the print order schema comprises a simplified print order schema for specifying a simplified printing intent.

3. A method according to claim 2, wherein a print order schema is associated with a product type.

4. A method according to claim 2, wherein a print order schema is shared between storefront and printing equipment.

5. A method according to claim 2, wherein deriving the execution context based in part upon the submitted print order includes deriving a simplified printing intent based on the print order schema upon receiving a submitted print order.

6. A method according to claim 2, wherein deriving the execution context includes obtaining dynamic information from a system context of a printing system.

7. A method according to claim 1, wherein the control schema is a simplified control schema for specifying a subset of control parameters of the print processing step.

8. A method according to claim 7, wherein the static context includes a control parameter template defining a preconfigured set of control parameters for a print processing step.

9. A method according to claim 8, wherein generating the at least one control parameter value includes generating an override value for a control parameter template based on the simplified control schema.

10. A method according to claim 1, wherein creating the pictorial plan comprises:
selecting a plurality of plan elements, wherein each plan element includes a symbol for representing the element in the pictorial plan;
configuring connections between some of the plurality of symbols, wherein a connection represents an information flow between plan elements; and
configuring at least one plan element to generate a control parameter value based on a type of dynamic information whose value can be obtained from the execution context.

11. A method according to claim 10, wherein the plurality of plan elements include an event element and an action element.

12. A method according to claim 11, wherein the event element is associated with an event type corresponding to a type of dynamic information recognizable by a printing system.

13. A method according to claim 12, including, upon recognizing the occurrence of a type of dynamic information and a pictorial plan including an event plan element of the corresponding event type, reporting an instance of an event of the corresponding type to the execution context of the pictorial plan.

14. A method according to claim 11, wherein the plurality of plan elements includes an event element associated with receiving a submitted print order.

15. A method according to claim 11, wherein the action element is associated with a function controllable by a printing system.

16. A method according to claim 15, wherein the function comprises a print processing step controllable by the printing system.

17. A method according to claim 15, including triggering an action element in response to the printing system reporting an instance of an event to the execution context for the pictorial plan wherein the pictorial plan includes the action element and wherein the event is of an event type associated with a connection to the action element.

18. A method according to claim 17, wherein triggering the action element occurs conditionally based on information configured while creating the pictorial plan and information from the execution context of the pictorial plan.

19. A method according to claim 18, wherein the information configured while creating the pictorial plan includes simple logic requiring limited programming skills.

20. A method according to claim 17, wherein triggering an action element includes creating event information for the action in the execution context.

21. A method according to claim 17, wherein creating event information for the action in the execution context includes creating event information based on information from the execution context of the pictorial plan and simple logic requiring limited programming skills.

22. A method according to claim 1, wherein the pictorial plan is configured as a plurality of pictorial plan portions to further simplify creation of the pictorial plan.

23. A method according to claim 1, wherein the print processing step comprises printing by a digital printer.

24. A method according to claim 1, wherein the print order conforms to a version of a JDF specification.

25. A method according to claim 1, wherein the control parameters delivered to the print processing step conform to a version of a JDF specification.
